(19) United States
(12) Patent Application Publication
(10) Pub. No.: US 2009/0306146 A1
(43) Pub. Date: Dec. 10, 2009

(54) Nicotinyls, Pyrethroids, and Ketoenols as a Gel Formation or Foam Formulation for Perennial Cultures

(75) Inventors: Isidro Bailo-Schleiermacher, Leverkusen (DE); Christian Nagel, Ho Chi Minh City (VN)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 12/066,847

(22) PCT Filed: Sep. 7, 2006
(86) PCT No.: PCT/EP2006/008844

§ 371 Date: Jul. 23, 2008

(30) Foreign Application Priority Data
Sep. 20, 2005 (DE) 10 2005 044 826.7

(51) Int. Cl. A01N 43/40; A01N 53/02; A01P 7/04

(52) U.S. Cl. 514/341; 514/343; 514/531; 514/675

(57) ABSTRACT

Method of controlling insects with a gel or foam formulation containing at least one insecticidal active substance, characterized in that the agrochemical formulation is applied externally to the trunk of the plant to be protected.

The present invention relates to the use of insecticide-containing gels or foams for the effective protection of perennial crops from migrating animal pests.

Most perennial crops, for example, vines, citrus fruit, pome fruit, stone fruit, nut trees and tea are attacked by insects which migrate from the soil, either from the root zone or other areas. Along the base of the trunk, they reach the upper growth zones of the perennial plants, which comprise leaves, fruits, nuts or other vegetative material of the plant. Traditional methods of controlling these pests are either soil applications by means of granules or pourable solution or else foliar applications of crop protection products. These application methods frequently fail to attain the required efficies because the pests (for example mealybugs, Phylloxera, wood beetles, scale insets, psyllids and the like) are, at the time of application, in well-protected stages or are protected in the soil by dwelling deep in the soil or, on the plant, by hiding under the bark or other plant parts. Soil application should therefore be carried out shortly before the animals migrate to the soil surface, and foliar application shortly before they migrate from the protected zones into the vegetative zones. This time window is difficult to define under practical conditions since individual pests may be in different phases or the plants may suffer from different phases of the attack. Economically meaningful and ecologically ideal application at the correct point in time are almost impossible to achieve. Spray applications must be carried out repeatedly at different points in time to ensure an optimal result. This increases the time required of the farmer and the pollution of the environment as the result of increased application rate of the active substances. Again, it can be seen that the known treatment methods suffer from economical and ecological weaknesses.

There is therefore a great need for a method of applying effective amounts of insecticides which avoids these specific difficulties. It is already known to employ foam formulations in the protection of buildings and materials (for example U.S. Pat. No. 6,290,992, U.S. Pat. No. 6,036,970, JP-A2 08259402). However, this takes the form of the protection of buildings or electrical systems (for example transformer casings) from attack by pests, mainly termites or rodents. An application at the surface of plants is neither disclosed by, nor obvious from, these applications.

The use of gels or foams as baits (for example WO 91/07972, WO 03/94612, JP-A2 2003 284477, U.S. Pat. No. 5,968,540) is also known. However, the aim here is that the harmful insects are trapped by the bait and then come into contact with the insecticides which they contain. An application in the natural environment or on the expected trails of the insects or other harmful animals (for example rats) therefore does not necessarily take place. Baits are usually employed within buildings. However, an application at the surface of plants is neither disclosed by, nor obvious from, these applications.

Also known are sticky bands which are arranged around the trunks of plants. These bands are coated with an adhesive and cause the insects which run or crawl across them to be retained and then die. However, they do not contain insecticidally active substances. Moreover, they have to be adapted to suit the trunk diameter, which is time-consuming, and exchanged after a certain time, when an unduly large surface area is occupied by retained insects.

Surprisingly, it has now been found that the application of the gel or foam formulations on the trunk of plants provides an effective protection from migrating harmful insects. A comparable protection is not achieved with the known application forms (pouring or spraying), or only with considerable complexity or with high application rates as the result of repeated application. In the method according to the invention, the insecticide, in the form of a gel or foam formulation, is applied externally to the trunk in the shape of a ring. As the result of the type of application, the location and efficiency of the product in this form remains stable over a prolonged period, and the product necessarily comes into contact with the animal pests when the latter migrate. During this contact, the insecticide acts on the animal pests and results in their death. As the result of the high stability of the formulation, the treatment only has to be carried out once before the expected migration of the harmful insects, so that the application rate of active substance is low. Moreover, as the result of the formulation of the crop protection product as a gel or foam, the application to the trunk of the plant is very quick and easy.

Gels are colloids in which the disperse phase together with the continuous phase forms a jelly-like product with the following characteristics: “Brookfield viscosity” (20 revolutions per minute at 25° C., spindle #7) more than 20 000 mPa•s and a Brookfield Yield point greater than 50.

However, suitable gel or foam formulations for the method according to the invention are in principle any which, under the use conditions, i.e. transient temperatures, sunlight and precipitation, are sufficiently dimensionally stable and long-lived and have a sufficiently duration of action in order to adhere to the trunk, and remain effective, over the entire treatment period.

Gels are preferably suitable as agrochemical formulations for the method according to the invention.

Suitable formulations can be prepared by known methods or are commercially available as premises for domestic hygiene compositions, for example comprising the insecticidal active substances imidacloprid (sold as the Premise®, Proficid® Aktiv, PreEmpt® and Blattanex® Ultra brands, Bayer CropScience AG, Monheim, Germany) or d-phenothrin and tetramethrin (“Blattanex Wespenschaum”®, Bayer CropScience AG, Monheim, Germany).

In principle, the method according to the invention is suitable for all plants.

The method is preferably suitable for treating perennial crops. The method is preferably suitable for treating vines, citrus trees, pome and stone fruit trees, nut trees and tea plants.

The method according to the invention is very especially preferably suitable for treating vines, citrus trees, orange trees, mandarin trees, grapefruit trees, apple trees, pear trees, quince trees, medlar trees, apricot trees, cherry trees, mirabelle trees, nectarine trees, peach trees, plum trees, greengage trees or nut trees and on tea bushes.

The method according to the invention is especially preferably suitable for treating plum trees.

In principle, the method according to the invention is suitable for controlling all harmful insects which migrate from the soil or the soil surface along the trunk into the vegetative zones of the plants which they attack.

The method according to the invention is preferably suitable for controlling all harmful insects which migrate from the soil or the soil surface along the trunk into the vegetative zones of vines, citrus trees, pome and stone fruit trees, nut trees and tea plants.

The method is preferably suitable for controlling mealybugs, Phylloxera, wood beetles, scale insects and psyllids.

When carrying out the method according to the invention, the agrochemical formulation is applied externally to the trunk.

The agrochemical formulation is preferably applied externally to the trunk above the soil and below the zones with active growth.

The agrochemical formulation is especially preferably applied on the outside of the trunk above the soil and below the zones of active growth in the form of a complete ring.

Examples of suitable insecticidal active substances in the agrochemical formulation according to the invention are the following active substances:

Acetylcholine Esterase (AChE) Inhibitors
carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

Sodium Channel Modulators/Voltage-Dependent Sodium Channel Blockers
pyrethroids,
for example acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-Fluvalinate, tefluthrin, terallethrin, tetramethrin (1R isomer), tralomethrin, transfluthrin, ZXI 8901, pyrethrins (pyrethrum)
DDT
oxadiazines,
for example indoxacarb

Acetylcholine Receptor Agonists/Antagonists
chloronicotinyls,
for example acetamiprid, clothianidin, dinotefuran, imidacloprid, nitenpyram, nithiazine, thiacloprid, thiamethoxam
nicotine, bensultap, cartap

Acetylcholine Receptor Modulators
spinosyns,
for example spinosad

GABA-Controlled Chloride Channel Antagonists
organochlorines,
for example camphechlor, chlordane, endosulfan, gamma-HCH, HCH, heptachlor, lindane, methoxychlor
fiproles,
for example acetoprole, ethiprole, fipronil, pyrafluprole, pyriprole, vaniliprole

Chloride Channel Activators
mectins,
for example avermectin, emamectin, emamectin-benzoate, ivermectin, milbemycin

Juvenile Hormone Mimetics,
for example diofenolan, epofenonane, fenoxycarb, hydroprene, kinoprene, methoprene, pyriproxifen, triprene

Ecdysone Agonists/Disruptors
diacylhydrazines,
for example chromafenozide, halofenozide, methoxyfenozide, tebufenozide

Chitin Biosynthesis Inhibitors
benzoylureas,
for example bistrifluron, chlofluazuron, diflubenzuron, fluazuron, flucycloxuron, flufenoxuron, hexaflumuron, lufenuron, novaluron, noviflumuron, penfluron, teflubenzuron, triflumuron
buprofezin
cyromazine

Oxidative Phosphorylation Inhibitors, ATP Disruptors
diafenthiuron
organotin compounds,
for example azocyclotin, cyhexatin, fenbutatin-oxide

Decouplers of Oxidative Phosphorylation by Interrupting the H Proton Gradient
pyrroles,
for example chlorfenapyr
dinitrophenols,
for example binapacyrl, dinobuton, dinocap, DNOC

Site-I Electron Transport Inhibitors
METIs,
for example fenazaquin, fenpyroximate, pyrimidifen, pyridaben, tebufenpyrad, tolfenpyrad
hydramethylnon
dicofol

Site-II Electron Transport Inhibitors
rotenone

Site-III Electron Transport Inhibitors
acequinocyl, fluacrypyrim

Microbial Disruptors of the Insect Gut Membrane
bacillus thuringiensis strains

Fat Biosynthesis Inhibitors
tetronic acids,
for example spirodiclofen, spiromesifen
tetramic acids,
for example spirotetramate (CAS-Reg.-No.: 203313-25-1) and 3-(2,5-dimethylphenyl)-8-methoxy-2-oxo-1-azaspiro[4.5]dec-3-en-4-yl ethyl carbonate (also known as: carbonic acid, 3-(2,5-dimethylphenyl)-8-methoxy-2-oxo-1-azaspiro[4.5]dec-3-en-4-yl ethyl ester, CAS-Reg.-No.: 382608-10-8)
carboxamides,
for example flonicamid
octopaminergic agonists,
for example amitraz

Inhibitors of Magnesium-Stimulated ATPase,
propargite
benzoic acid dicarboxamides,
for example flubendiamide
nereistoxin analogues,
for example thiocyclam hydrogen oxalate, thiosultap-sodium

Biologicals, Hormones or Pheromones
azadirachtin, Bacillus spec., Beauveria spec., codlemone, Metarrhizium spec., Paecilomyces spec., Thuringiensin, Verticillium spec.

Active Compounds With Unknown or Unspecific Mechanisms of Action
fumigants,
for example aluminium phosphide, methyl bromide, sulfuryl fluoride
antifeedants,
for example cryolite, flonicamid, pymetrozine
mite growth inhibitors,
for example clofentezine, etoxazole, hexythiazox
amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

Formulations according to the invention preferably contain at least one insecticidal active substance selected from the classes of the neonicotinyls, pyrethroids and ketoenols.

Especially preferred insecticidal active substances are imidacloprid, thiamethoxam, nitenpyram, thiacloprid, acetamiprid, dinotefuran, clothianidin, AKD-1022, acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, cis-cypermethrin, cis-resmethrin, cis-Permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum), spiromesifen, spirodiclofen, spirotetramate and 3-(2,5-dimethylphenyl)-8-methoxy-2-oxo-1-azaspiro[4.5]dec-3-en-4-yl ethyl carbonate (also known as: carbonic acid, 3-(2,5-dimethylphenyl)-8-methoxy-2-oxo-1-azaspiro[4.5]dec-3-en-4-yl ethyl ester, CAS-Reg.-No.: 382608-10-8).

Very especially preferred insecticidal active substances are imidacloprid, thiamethoxam, nitenpyram, thiacloprid, acetamiprid, dinotefuran, clothianidin, AKD-1022, acrinathrin, alpha-cypermethrin, beta-cyfluthrin, cypermethrin, deltamethrin, lambda-cyhalothrin, zeta-cypermethrin, cyfluthrin, bifenthrin, spiromesifen, spirodiclofen or spirotetramate.

The compositions according to the invention have an active substance content of from 1 to 70% by weight, preferably from 1 to 30% by weight, especially preferably from 1 to 10% by weight, very especially preferably from 1 to 3% by weight.

### USE EXAMPLE

Activity of an Imidacloprid-Containing Gel Against Pseudococcus citri Following Trunk Application (Pseudococcus citri-Test)

A gel containing 2.15% imidacloprid (“Blattanex Gel”®, Bayer CropScience AG) is applied in a defined width to young plant trunks at a height of approximately 3 cm.

Mobile instars of the citrus mealybug (Pseudococcus citri) are placed at the base of the trunk, from where they populate the plant.

After the desired period of time the activity is determined in % protection. 100% means that the citrus mealybugs were incapable of populating the plant; 0% means that the Pseudococcus citri population on the plant is comparable with that of the control.

In this test, the application of a gel shows a pronounced activity.

TABLE A
Plant-injurious insect
Pseudococcus citri - Trunk application

| | Concentration | Protection |
|---|---|---|
| Active substance/product | in % | in % after 20^{d} |
| Imidacloprid gel | 2.15 | 95.5 |
| according to the invention | | |
| Control | | 0 |

1. A method of controlling harmful insects, comprising applying a gel or foam formulation containing at least one insecticidal active substance externally to a plant.

2. A method according to claim 1, wherein the formulation comprises at least one active substance selected from the group consisting of neonicotinyls, pyrethroids, ketoenols and mixtures thereof.

3. A method according to claim 1, wherein the formulation comprises at least one active substance selected from the group consisting of imidacloprid, d-phenothrin, tetramethrin, spiromesifen, spirodiclofen, spirotetramate and mixtures thereof.

4. A method according to claim 1, wherein the formulation comprises an insecticidal active substance in a concentration of from 1 to 70% by weight.

5. A method according to claim 1, wherein the formulation comprises imidacloprid in a concentration of from 1 to 3% by weight.

6. A method according to claim 1, wherein, the formulation is applied above the soil and below the vegetative zone of the plant to be treated.

7. A method according to claim 1, wherein, the formulation is applied in the form of a complete ring.

8. A method according to claim 1, wherein, said plant is selected from the group consisting of vines, citrus trees, pome and stone fruit trees, nut trees and tea plants.

9. A method according to claim 1, wherein, said plant is selected from the group consisting of vines, citrus trees, orange trees, mandarin trees, grapefruit trees, apple trees, pear trees, quince trees, medlar trees, apricot trees, cherry trees, mirabelle trees, nectarine trees, peach trees, plum trees, greengage trees, nut trees, and tea bushes.

10. A method according to claim 1, wherein, said plant is a plum tree.

11. A method according to claim 1, wherein, the insects to be controlled are selected from the group consisting of mealybugs, Phylloxera, wood beetles, scale insects and psyllids.

12. A method according to claim 1, wherein the formulation is a gel comprising 1 to 3% by weight of imidacloprid and, wherein said gel is applied to the trunk of a fruit tree in the shape of a complete ring.

13. A method according to claim 2, wherein the formulation is applied above the soil and below the vegetative zone of the plant to be treated.

14. A method according to claim 2, wherein the formulation is applied in the form of a complete ring.

15. A method according to claim 2, wherein said plant is selected from the group consisting of vines, citrus trees, pome and stone fruit trees, nut trees and tea plants.

16. A method according to claim 2, wherein said plant is a plum tree.

17. A method according to claim 2, wherein the insects to be controlled are selected from the group consisting of mealybugs, Phylloxera, wood beetles, scale insects and psyllids.

18. A method according to claim 2, wherein the formulation is a gel comprising 1 to 3% by weight of imidacloprid and, wherein said gel is applied to the trunk of a fruit tree in the shape of a complete ring.
